(19) United States
(12) Patent Application Publication
(10) Pub. No.: US 2014/0366156 A1
(43) Pub. Date: Dec. 11, 2014

(54) METHOD AND DEVICE FOR PROTECTING PRIVACY INFORMATION WITH BROWSER

(71) Applicant: Tencent Technology (Shenzhen) Company Limited, Shenzhen (CN)

(72) Inventor: Jing Liu, Shenzhen (CN)

(21) Appl. No.: 14/338,867

(22) Filed: Jul. 23, 2014

Related U.S. Application Data
(63) Continuation of application No. PCT/CN2013/090880, filed on Dec. 30, 2013.

(30) Foreign Application Priority Data
Jun. 9, 2013 (CN) 201310230935.4

(51) Int. Cl. G06F 21/60

(52) U.S. Cl. CPC G06F 21/60
USPC 726/27

(57) ABSTRACT

A method and device for protecting privacy information with a browser are provided. The method includes: monitoring a file to be uploaded by the browser when an uploading process of the browser is executed; determining whether the file to be uploaded includes preset identification information; and blocking the file that is determined to include the preset identification information from being uploaded. With the technical solution, a privacy file is prevented from being stolen when an illegitimate website is accessed by the browser, and accordingly the security of user information is effectively improved.

The present application is a continuation application of International Application No. PCT/CN2013/090880, filed on Dec. 30, 2013, which claims the priority to Chinese Patent Application No. 201310230935.4, entitled as “METHOD AND DEVICE FOR PROTECTING PRIVACY INFORMATION WITH BROWSER”, filed on Jun. 9, 2013 with State Intellectual Property Office of People's Republic of China, both of which are hereby incorporated by reference in their entireties.

### TECHNICAL FIELD

The present disclosure relates to web browsers, and in particular to a method and device for protecting privacy information with a browser.

### BACKGROUND

When a terminal such as a mobile phone or a computer uses a browser to browse a web page, the browser usually performs security detection on the web page being browsed in order to protect user privacy, prevent computer viruses, such as Trojan, from invading the computer to steal privacy information of a user, and to timely prevent Trojan of an illegitimate website from invading a local computer.

Usually the security detection is performed based on preset illegitimate website database that contain predetermined or known illegitimate websites. Data in the illegitimate website database is reported by users or collected by other methods. When new illegitimate websites emerge, the illegitimate website database may not be updated timely to capture the new illegitimate websites, thereby making the computer vulnerable to virus attack. Once a Trojan virus is reproduced in the user's computer, the user's privacy information becomes accessible to the illegitimate websites, resulting in a privacy breach.

### SUMMARY

In view of this, a method for protecting privacy information with a browser is provided according to embodiments of the disclosure to solve the prior art problem that the privacy file of the user may become easily accessible by an illegitimate webpage. The method of the present disclosure improves security of user information.

In one aspect, a method for protecting privacy information with a browser is provided according to an embodiment of the disclosure. The method includes: monitoring a file to be uploaded by the browser when an uploading process of the browser is executed; determining whether the file to be uploaded includes preset identification information; and blocking the file that is determined to include the preset identification information from being uploaded.

In another aspect, a device for protecting privacy information with a browser is provided according to an embodiment of the disclosure. The device includes: a monitoring unit that monitors a file to be uploaded by the browser when an uploading process of the browser is executed; a determination unit that determines whether the file to be uploaded includes preset identification information; and a blocking unit that blocks the file that is determined to include the preset identification information from being uploaded.

According to the embodiments of the disclosure, the file to be uploaded by the browser is monitored when the browser is running. If it is monitored that the file to be uploaded includes the preset identification information, the uploading of the file including the preset identification information is blocked. Even if the webpage to be retrieved by the browser includes malicious viruses or Trojans which will access local privacy information, the privacy information may not be uploaded by the browser. The technical solution of the disclosure may prevent local privacy files from being stolen when an illegitimate website is accessed or retrieved by the browser. Therefore, the security of user information is improved effectively.

### BRIEF DESCRIPTION OF DRAWINGS

FIG. 1 is a flow chart of a method for protecting privacy information with a browser according to a first embodiment of the disclosure;

FIG. 2 is a flow chart of a method for protecting privacy information with a browser according to a second embodiment of the disclosure;

FIG. 3 is a schematic structure diagram of a device for protecting privacy information with a browser according to a third embodiment of the disclosure; and

FIG. 4 is a block diagram of part structures of a terminal such as a mobile phone according to a fourth embodiment of the disclosure.

### DETAILED DESCRIPTION OF EMBODIMENTS

For making the objective, technical solution and advantages of the disclosure more clearly, the disclosure is further explained hereinafter in conjunction with drawings. It should be understood that, embodiments described here are merely intended to explain the disclosure rather than limit the disclosure.

The embodiments of the disclosure may be applied in a terminal such as mobile phone, computer, etc. When a browser in the terminal is used to access or retrieve a webpage, viruses and Trojans in some illegitimate websites may inevitably attack the terminal. If a privacy file is not effectively protected, the privacy a user may be compromised. A method for protecting privacy information with a browser is provided according to an embodiment of the disclosure to solve the prior art security problems without affecting a file uploading function of the browser. The method includes: monitoring a file to be uploaded by the browser when an uploading process of the browser is executed; determining whether the file to be uploaded includes preset identification information; and blocking the file including the preset identification information. According to the embodiments of the disclosure, even if the webpage accessed or retrieved by the browser includes some viruses or Trojans which will access local privacy information, the privacy information may not be uploaded by the browser. The technical solution of the disclosure may prevent local privacy files from being stolen when an illegitimate website is accessed by the browser. Therefore, the security of user information is effectively improved.

### A First Embodiment

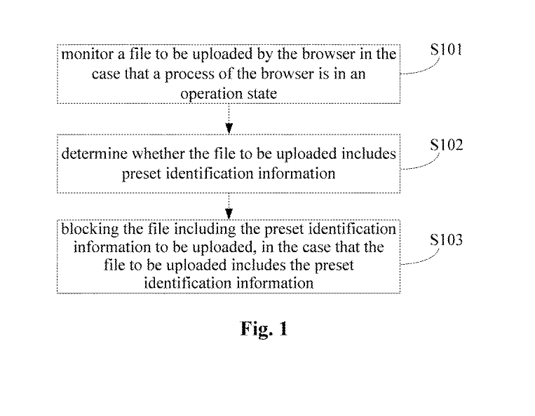

FIG. 1 illustrates a flow chart of a method for protecting privacy information with a browser according to the first embodiment of the disclosure. The method includes steps 101-103.

The step 101 is to monitor a file to be uploaded by the browser when an uploading process of the browser is executed.

When the server is running, a behavior of uploading the file, which is performed in foreground or in background, is monitored. When the browser has an uploading task, the step 102 is executed to perform a determination on the file to be uploaded.

The file to be uploaded and protected may include multiple types. In a smart phone, the file to be uploaded and protected may include but not be limited to: contact list, images, short messages and other text messages. Hence, contact information and communication privacy of contacts in the smart phone may be protected. In a computer terminal, the file to be uploaded and protected may include but not be limited to: various kinds of text files, image or video files, or folder including privacy information.

Monitoring the file to be uploaded may be performed by monitoring a process of uploading, and more specifically by monitoring a web browsing and obtaining information of the file to be uploaded by using a traffic monitoring software.

The step 102 is to determine whether the file to be uploaded includes preset identification information.

According to the embodiment of the disclosure, the file to be uploaded may include but not be limited to: the file to be uploaded by the browser; and the file with the preset identification information, which is locally uploaded with other protocols or interfaces. For example, uploading with download protocols applied in various download tools.

The preset identification information may include any one of a name of a file, storage path information of the file and verification information of the file, or the combination thereof.

If the identification information is the name of the file, the preset identification information may be stored in a name library. The step of determining includes: comparing the name of the file to be uploaded with all names in the preset name library; and determining that the file to be updated includes the preset identification information, if the name of the file to be uploaded matches a name in the preset name library.

If the identification information is the storage path information of the file, the preset identification information may be stored in a set of storage paths. The step of determining includes: inquiring the storage path of the file to be uploaded; comparing the inquired storage path with the storage paths in the set of storage paths; and determining that the file to be updated includes the preset identification information, if the inquired storage path is the same as a storage path in the storage path set. Usually, multiple files may share one storage path (all files under one folder have the same storage path). Thus, when the identification information is the storage path information of the file, the files sharing the matched storage path are all protected. Usually, this case is applied to protect the files in the computer terminal.

If the identification information is the verification information of the file, the preset identification information may be stored in a database of verification results of files. The file may be verified with Cyclic Redundancy Check (CRC). The step of determining includes: obtaining a verification result by performing the CRC on the file to be uploaded; comparing the obtained verification result with the verification results in the preset database; and determining that the file to be updated includes the preset identification information, when the obtained verification result is the same as a verification result in the preset database. The basic principle of the CRC is described as follows. An R-bit verification code is added after a K-bit information code to generate an N-bit code, which is also called an (N, K) code, where N=K+R. For a given (N, K) code, it is proved that there is a polynomial G(x) having a term with the highest power of R. The verification code of the K-bit information may be generated from the G(x), and the G(x) is called a generator polynomial of the CRC verification code. The CRC verification code is generated by assuming that sent information is represented by an information polynomial C(x). The combination of the coefficients of the information polynomial C(x) is the information code. The information code is shifted to left in R bits to obtain a new code. A polynomial corresponding to the new code may be indicated by C(x)*R power of x. In this case, the left of the information code may be added R bits for the verification code. The C(x)*R power of x is divided by the polynomial G(x) to obtain a remainder polynomial. The verification code consists of coefficients of the remainder polynomial.

Any one of the three determination methods may be individually implemented. Obviously, any two or all of the determination methods may be combined in implementation. For example, the determination is performed based on the name and the storage path of the file, the name and the verification result of the file, or the name, the storage path and the verification result of the file. The combination increases the accuracy of determination, reduces the likelihood of false determination, and accordingly, it is convenient to use.

The step 103 is to block the file including the preset identification information to be uploaded, when the file to be uploaded includes the preset identification information.

In the step 102, it is determined whether the file to be uploaded includes the preset identification information. If the file includes the preset identification information, the uploading of the file including the preset identification information is blocked.

When the file is to be uploaded by the browser and when it is determined that the file includes the preset identification information, the browser blocks the task to be uploaded and cancels the uploading of the file.

When the file is to be uploaded with other ports or protocols and when it is determined that the file includes the preset identification information, a warning notification may be sent to other software based on a preset protocol. The warning notification is adapted to prompt that the file to be uploaded may affect privacy and the uploading task should be stopped immediately. For example, the warning notification is sent by the browser to a security manager or anti-virus software based on the preset protocol, so as to immediately stop the uploading of the file.

According to the embodiment of the disclosure, the file to be uploaded by the browser is monitored when the uploading process of the browser is executed. If it is monitored that the file to be uploaded includes the preset identification information, the uploading of the file including the preset identification information is blocked. Even if the webpage accessed by the browser includes some viruses or Trojans which will access local privacy information, the privacy information may not be uploaded by the browser. The technical solution of the disclosure may prevent local privacy files from being stolen when an illegitimate website is accessed by the browser. Therefore, the security of user information is improved effectively.

### A Second Embodiment

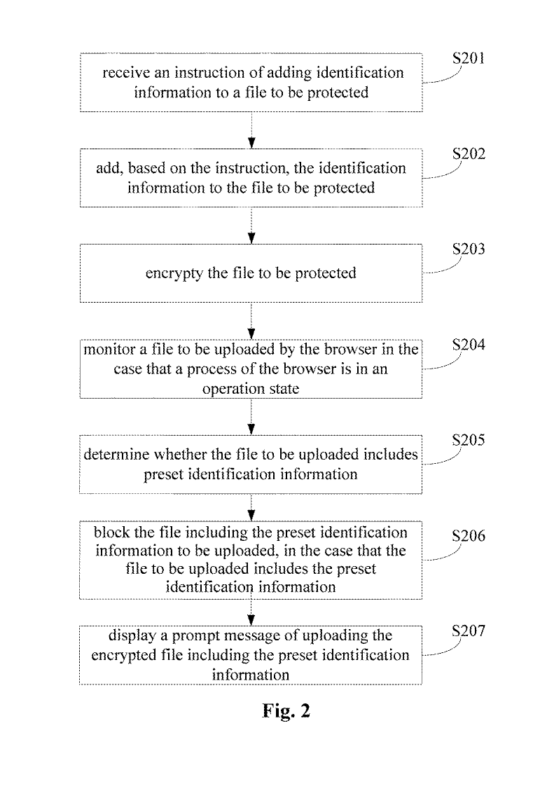

FIG. 2 illustrates a flow chart of a method for protecting privacy information with a browser according to the second embodiment of the disclosure. The method includes steps 201-107.

The step 201 is to receive an instruction to add identification information to a file to be protected.

The step 202 is to add, based on the instruction, the identification information to the file to be protected.

Corresponding identification information, for example, a storage path of the file, the name of the file, a verification result of the file, should be added to the file to be protected.

For a smart phone terminal, the name of the file is recorded. For example, the names of a file for storing a contact list and a file for storing short messages are recorded. Alternatively, the name of the file and the storage path of the file are simultaneously recorded. For a computer terminal, verification such as the CRC may be performed on the file to be protected to obtain the verification result.

The file to be protected may firstly be added into a secret safe of a browser. Then, the files to be protected such as a contact list, a message, etc. are selected in the secret safe of the browser. Alternatively, the file to be protected may be added by importing the file.

The step 203 is to encrypt the file to be protected.

After being added the identification information, the file to be protected may further be encrypted. The file may be encrypted by using a file encryption function of the WINDOWS system, or by using commercial encryption software with encryption algorithms. The commercial encryption software further includes driver-level encryption software and plugin-level encryption software. Encryption algorithms may include: a symmetric International Data Encryption Algorithm (IDEA), an asymmetric ROSA algorithm and an irreversible Advanced Encryption Standard (ACES) algorithm. The security of the file is further improved by encrypting the file to be protected and limiting an access for the file to be protected.

The step 204 is to monitor a file to be uploaded by the browser, when an uploading process of the browser is executed.

The step 205 is to determine whether the file to be uploaded includes preset identification information.

The step 206 is to block the file including the preset identification information to be uploaded when the file to be uploaded includes the preset identification information.

The steps 204-206 are similar to the steps 101-103 in the first embodiment, and thus the description thereof is omitted herein.

The step 207 is to display a prompt message of uploading the encrypted file including the preset identification information.

After the uploading of the file including the preset identification information is blocked, the prompt message of uploading the encrypted file including the preset identification information is displayed to timely inform a user of a security situation of a current terminal with assurance of the security of a current file. On the one hand, a possible operation of the user manually uploading the file with the preset identification information may be avoided. On the other hand, the user may be informed that a current system may be infected with viruses, and the user may timely remove the virus from the system. The security of the system is improved.

According to the embodiment of the disclosure, the security of the file to be protected may be improved by encrypting the file to be protected. The efficiency of accessing is improved by limiting the process accessing the file to be protected. After the uploading of the file including the preset identification information is blocked, the prompt message of uploading the encrypted file including the preset identification information is displayed to prompt the user to timely remove the viruses from the system.

### A Third Embodiment

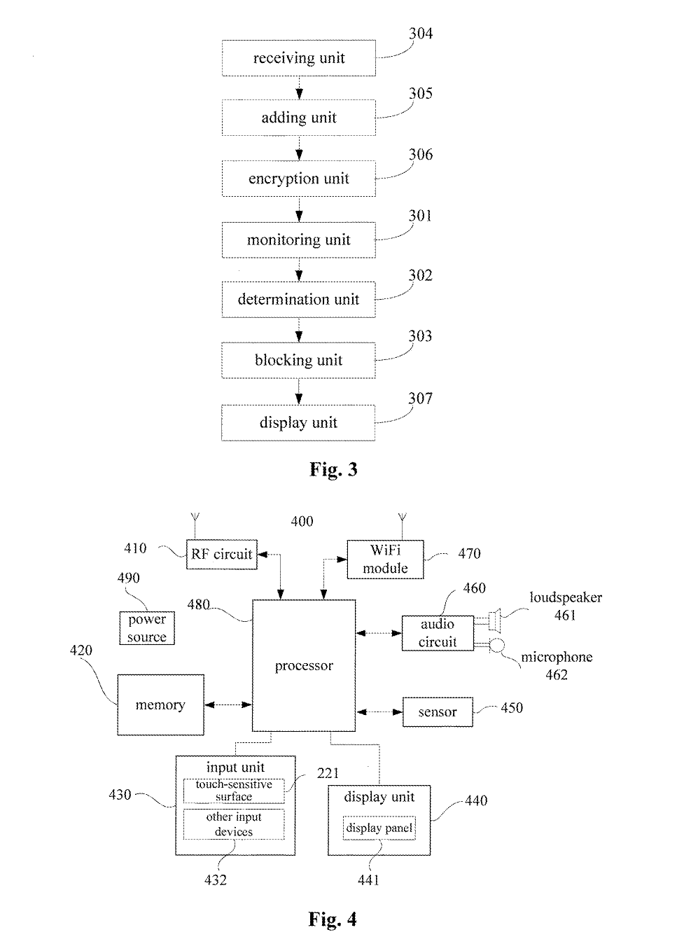

FIG. 3 illustrates a schematic structure diagram of a device for protecting privacy information with a browser according to the third embodiment of the disclosure.

The device for protecting privacy information with the browser according to the embodiment of the disclosure includes a monitoring unit 301, a determination unit 302 and a blocking unit 303.

The monitoring unit 301 is adapted to monitor a file to be uploaded by the browser, when an uploading process of the browser is executed.

The determination unit 302 is adapted to determine whether the file to be uploaded includes preset identification information.

The blocking unit 303 is adapted to block the file including the preset identification information to be uploaded when the file to be uploaded includes the preset identification information.

According to another embodiment, the device further includes a receiving unit 304 and an adding unit 305.

The receiving unit 304 is adapted to receive an instruction to add identification information to a file to be protected.

The adding unit 305 is adapted to add, based on the instruction, the identification information to the file to be protected.

For further improving the security of the file, the device according to the embodiment of the disclosure may further include an encryption unit 306 adapted to encrypt the file to be protected.

For timely prompting the security of a device, the device may further include a display unit 307 adapted to display a prompt message of uploading the encrypted file including the preset identification information.

According to the embodiment of the disclosure, the identification information includes any one of the name of the file, storage path information of the file and verification information of the file, or the combination thereof.

When the identification information is the name of the file, the preset identification information may be stored in a name library. The determining unit 302 is further adapted to compare the name of the file to be uploaded with all names in the preset name library; and determine that the file to be updated includes the preset identification information, when the name of the file to be uploaded matches with a name in the preset name library.

When the identification information is the storage path information of the file, the preset identification information may be stored in a set of storage paths. The determining unit 302 is further adapted to inquire the storage path of the file to be uploaded; comparing the inquired storage path with the storage paths in the set of storage paths; and determine that the file to be updated includes the preset identification information, when the inquired storage path is the same as a storage path in the storage path set.

When the identification information is the verification information of the file, the preset identification information may be stored in a database of verification results of files. The determining unit 302 is further adapted to verifying the file to be uploaded to obtain a verification result; compare the obtained verification result with the verification results in the preset database; and determine that the file to be updated includes the preset identification information, when the obtained verification result is the same as a verification result in the preset database.

The device according to the embodiment of the disclosure corresponds to the methods according the first embodiment and the second embodiment, which will not be repeated herein.

### A Fourth Embodiment

FIG. 4 illustrates a structure block diagram of a mobile phone associated with a terminal according to the embodiment of the disclosure. As shown in FIG. 4, the mobile phone includes a Radio frequency (RF) circuit 410, a storage device 420, an input unit 430, a display unit 440, a sensor 450, an audio circuit 460, a wireless fidelity (WIFI) module 470, a processor 480, a power source 490, etc. Those skilled in the art should understand that the structure shown in FIG. 4 is for illustrative purposes and is not intended to limit the mobile phone to the structure shown in FIG. 4. More or fewer components may be included in the mobile phone shown in FIG. 4, and some components may be combined or may be arranged differently.

The various components of the mobile phone will be described in conjunction with FIG. 4.

The RF circuit 410 may be adapted to receive and send signals during receiving and sending messages or during making a phone call. Specifically, the RF circuit 410 receives downlink information from a base station, and transmits the information to one or more processors 480 to process. In addition, the RF circuit 410 sends uplink data to the base station. Usually, the RF circuit includes, but not is limited to, an antenna, at least one amplifier, a coordinator, one or more oscillators, a Subscriber Identity Module (SIM) card, a transceiver, a coupler, a Low Noise Amplifier (LNA), a duplexer, etc. In addition, the RF circuit 410 may also communicate with a network or other devices via wireless communication. The wireless communication may be operated in any communication standard or protocol, which includes, but is not limited to, Global System of Mobile communication (GSM), General Packet Radio Service (GPRS), Code Division Multiple Access (CDMA), Wideband Code Division Multiple Access (WCDMA), Long Term Evolution (LTE), email, Short Messaging Service (SMS), etc.

The memory 420 may be adapted to store a software program and module. The processor 480 is adapted to perform various function application and data processing by running the software programs or modules stored in the memory 420. The memory 420 may mainly include a program storage area and a data storage area. Specifically, the program storage area may store an operating system, an application required by at least one function (e.g., a playing audio function, a displaying image function), etc. The data storage area may store data (e.g., audio data, telephone book, etc.) created based on the usage of the mobile phone, etc. In addition, the memory 420 may include a high speed random access memory, a nonvolatile storage such as at least one magnetic disk storage or flash disk, and any solid volatile storage.

The input unit 430 may be adapted to receive digital information or character information that is input, and generate a signal input associated with a user setting and a function control of the mobile phone 400. The input unit 430 may include a touch-sensitive surface 431 and other input devices 432. The touch-sensitive surface 431, also called a touch screen or touch panel, may detect a touch operation by the user thereon or in the vicinity thereof, such as operations made by the user using any suitable object or accessory (such as a finger and a touch pen) on the touch-sensitive surface 221 or in the vicinity of the touch-sensitive surface 221. The touch-sensitive surface 431 then may drive a corresponding connection device based on a preset program. Optionally, the touch-sensitive surface 431 may include a touch detection device and a touch controller. The touch detection device is adapted to detect a touch position of the user, detect the signal caused by the touch operation, and send the signal to the touch controller. The touch controller is adapted to receive touch information from the touch detection device, convert the touch information into coordinates of a contact point, send the coordinates to the processor 480, and receive a command from the processor 480 to perform. In addition, the touch-sensitive surface 431 may be implemented into many types, e.g., resistance type, infrared type, Surface Acoustic Wave type. Besides the touch-sensitive surface 431, the input unit 430 may include other input devices 432. The other input devices 432 includes, but is not limited to, one or more of physical keyboard, function key (e.g., a volume control button, a switch button), trackball, mouse and operating rod.

The display unit 440 is adapted to display information inputted by the user, information provided to the user and various graphic user interfaces of the terminal. Those graphic user interfaces may include a graphic, a text, an icon and a video and any combination thereof. The display unit 440 may include a display panel 441. Optionally, the display panel 441 may be configured as for example Liquid Crystal Display (LCD), Organic Light-Emitting Diode (OLED) display. Furthermore, the touch-sensitive surface 431 may cover the display panel 441. When detecting a touch operation thereon or in the vicinity thereof, the touch-sensitive surface 431 sends the detected touch operation to the processor 480 to determine a type of the touch operation. The processor 480 then provides a corresponding visual output on the display panel 441 according to the type of the touch event. Although the touch-sensitive surface 431 and the display panel 441 are shown to be two independent components to achieve the input function and the output function in FIG. 4, the touch-sensitive surface 431 and the display panel 441 may be integrated together to achieve the input function and the output function according to some embodiments.

The mobile phone 400 may further include at least one sensor 450, e.g., a light sensor, a motion sensor and any other sensors. The light sensor may include an ambient light sensor and a proximity sensor. The ambient light sensor may adjust a brightness of the display panel 441 based on the intensity of ambient light. The proximity sensor may turn off the display panel 441 and/or a backlight when the mobile phone is close to an ear. As an example of the motion sensor, a gravity acceleration sensor may detect an acceleration value in each direction (usually, in three axial direction), and detect a value and a direction of the gravity in a stationary state. The gravity acceleration sensor may be used for identifying the attitude of a cell phone (such as orientation change, related games, or magnetometer attitude calibration), and a function related to vibration identification (such as a pedometer, or a knock). Other sensors, such as gyroscope, barometer, hygrometer, thermometer, infrared sensor may also be provided in the mobile phone.

An audio interface between the user and the terminal may be provided by the audio circuit 460, a loudspeaker 461 and a microphone 462. The audio circuit 460 may receive audio data, converts the audio data into an electrical signal, and transmit the electric signal, which is converted from the received audio data, to the loudspeaker 461. The loudspeaker 461 then converts the electrical signal into a sound signal to output. On the other hand, the microphone 462 receives and converts the captured sound signal into an electric signal. The audio circuit 460 receives the electric signal, converts the electric signal into audio data and outputs the audio data to the processor 480 for further processing. The processed audio data is then sent to another mobile phone via the RF circuit 410 or output to the memory 420 for further processing.

WIFI is one short-distance wireless transmission technology. The mobile phone may assist the user to receive and send e-mails, browse webpages, access a stream media, etc. via the WIFI module 470. The WIFI module 470 provides a wireless broadband internet access to the user. Although the WIFI module 470 is shown in FIG. 4, it should be understood that the WIFI module is not necessary for the mobile phone 400, and can be omitted without departing from the scope of the present disclosure.

The processor 480, as a control center of the mobile phone, is adapted to connect all components of a whole mobile phone via various interfaces and wires, and execute various functions of the mobile phone and process the data by running or executing the software programs and/or software modules stored in the memory 420, and invoking data stored in the memory 420. Therefore, the whole mobile phone is monitored. Optionally, the processor 480 may include one or more processing cores. Preferably, the processor 480 may be integrated with an application processor and a modem processor, where the application processor is mainly adapted to process an operating system, a user interface, an application, etc., and the modem processor is mainly adapted to process wireless communication. It may be understood that the modem processor described above may not be integrated in the processor 480.

The mobile phone 400 further includes the power source 490 (such as a battery) supplying power to all the components. Preferably, the power source may be logically connected to the processor 480 via a power management system in order to implement functions of charging management, discharging management, power consumption management, etc.

Although not illustrated, the mobile phone 400 may further include a camera, a Bluetooth module, etc.

According to an embodiment of the disclosure, the processor 480 included in the terminal may further be adapted to execute a method for protecting privacy information with a browser. The method includes: monitoring a file to be uploaded by the browser, when an uploading process of the browser is executed; determining whether the file to be uploaded includes preset identification information; and blocking the file including preset identification information.

Furthermore, the processor 480 is further adapted to receive an instruction to add identification information to a file to be protected; and add, based on the instruction, the identification information to the file to be protected.

Furthermore, the processor 480 is further adapted to encrypt the file to be protected; and display a prompt message of uploading the encrypted file including the preset identification information.

The embodiments described above are merely preferred embodiments of the disclosure. The described embodiments are not intended to limit the disclosure. Any change, equivalent replacement and modification without departing from the spirit and principle of the disclosure should fall in the scope of protection of the disclosure.

What is claimed is:

1. A method for protecting privacy information stored in a terminal with a browser, comprising:
monitoring a file to be uploaded by the browser when an uploading process of the browser is executed;
determining whether the file to be uploaded includes preset identification information to be protected; and
blocking the file that is determined to comprise the preset identification information from being uploaded.

2. The method according to claim 1, wherein before the monitoring a file to be uploaded by the browser when an uploading process of the browser is executed, the method further comprises:
receiving an instruction to add identification information to a file to be protected; and
adding, based on the instruction, the identification information to the file to be protected.

3. The method according to claim 1, wherein the identification information comprises at least one of a name of a file, storage path information of the file and verification information of the file.

4. The method according to claim 3, wherein the preset identification information is stored in a name library, and
the determining that the file comprises preset identification information comprises:
comparing the name of the file to be uploaded with names in the preset name library; and
determining that the file to be updated comprises the preset identification information, when the name of the file to be uploaded matches with a name in the preset name library.

5. The method according to claim 3, wherein the preset identification information is stored in a set of storage paths, and
the determining that the file comprises preset identification information comprises:
inquiring a storage path of the file to be uploaded; comparing the inquired storage path with storage paths in the set of storage paths; and
determining that the file to be updated comprises the preset identification information, when the inquired storage path is the same as a storage path in the storage path set.

6. The method according to claim 3, wherein the preset identification information is stored in a database of verification results of files, and
the determining that the file comprises preset identification information comprises:
verifying the file to be uploaded to obtain a verification result;
comparing the obtained verification result with verification results in the database; and
determining that the file to be updated comprises the preset identification information, when the obtained verification result is the same as a verification result in the database.

7. The method according to claim 2, wherein after the receiving an instruction to add identification information to a file to be protected, the method further comprises:
encrypting the file to be protected.

8. The method according to claim 1, wherein after the blocking the file including the preset identification information to be uploaded, when the file to be uploaded includes the preset identification information, the method further comprises:
displaying a prompt message of uploading the file comprising the preset identification information.

9. A device for protecting privacy information with a browser, comprising:
a monitoring unit that monitors a file to be uploaded by the browser when an uploading process of the browser is executed;
a determination unit that determines whether the file to be uploaded comprises preset identification information; and
a blocking unit that blocks the file that is determined to comprise the preset identification information from being uploaded.

10. The device according to claim 9, wherein the device further comprises:
a receiving unit that receives an instruction to add identification information to a file to be protected; and
an adding unit that adds the identification information to the file to be protected based on the instruction.

11. The device according to claim 9, wherein the identification information comprises at least one of a name of a file, storage path information of the file and verification information of the file.

12. The device according to claim 11, wherein the preset identification information is stored in a name library, and
the determination unit is further adapted to
comparing the name of the file to be uploaded with names in the preset name library; and
determining that the file to be updated comprises the preset identification information, when the name of the file to be uploaded matches with a name in the preset name library.

13. The device according to claim 11, wherein the preset identification information is stored in a set of storage paths, and
the determination unit is further adapted to
inquire a storage path of the file to be uploaded; compare the inquired storage path with storage paths in the set of storage paths; and
determine that the file to be updated comprises the preset identification information, when the inquired storage path is the same as a storage path in the storage path set.

14. The device according to claim 11, wherein the preset identification information is stored in a database of verification results of files, and
the determination unit is further adapted to
verify the file to be uploaded to obtain a verification result; compare the obtained verification result with verification results in the database; and
determine that the file to be updated comprises the preset identification information, when the obtained verification result is the same as a verification result in the database.

15. The device according to claim 10, wherein the device further comprises:
an encryption unit adapted to encrypt the file to be protected.

16. The device according to claim 9, wherein the device further comprises:
a display unit that displays a prompt message of uploading the file including the preset identification information.

17. A non-transitory computer storage medium comprising a computer executable instruction, wherein the computer executable instruction performs a method for protecting privacy information with a browser, comprising:
monitoring a file to be uploaded by the browser when an uploading process of the browser is executed;
determining whether the file to be uploaded comprises preset identification information; and
blocking the file that is determined to comprise the preset identification information from being uploaded.

18. The non-transitory computer storage medium according to claim 17, before the monitoring a file to be uploaded by the browser when an uploading process of the browser is executed, the method further comprises:
receiving an instruction to add identification information to a file to be protected; and
adding, based on the instruction, the identification information to the file to be protected.

19. The non-transitory computer storage medium according to claim 17, wherein the identification information comprises at least one of a name of a file, storage path information of the file and verification information of the file.

20. The non-transitory computer storage medium according to claim 18, wherein after the receiving an instruction to add identification information to a file to be protected, the method further comprises:
encrypting the file to be protected.
